(19) United States
(12) Patent Application Publication
(10) Pub. No.: US 2005/0040229 A1
(43) Pub. Date: Feb. 24, 2005

(54) Portable security device

(76) Inventors: Karl Andrews, Hoppers Crossing (AU); Glen Frank Kouacic, Hoppers Crossing (AU)

Correspondence Address: DANIEL J SWIRSKY, PO BOX 2345, BEIT SHEMESH, 99544, IL

(21) Appl. No.: 10/488,773

(22) PCT Filed: Sep. 6, 2002
(86) PCT No.: PCT/AU02/01230

(30) Foreign Application Priority Data
Sep. 6, 2001 (AU) PR 7533
Sep. 6, 2002 (AU) 2002100709

(51) Int. Cl. G06K 5/00

(52) U.S. Cl. 235/382

(57) ABSTRACT

This security luggage device is typically an electronic device integrally incorporated in an item of personal luggage equipped with an electronic alert siren (alarm), a movement sensitive electronic trigger, a self-contained wireless remote control, a numeric keypad enabling numeric sequential security entry, arming and disarming of motion sensor and alert siren (alarm).

The present invention relates generally to security devices and, in particular, to portable or transportable security devices, particularly security devices that can be attached to a container or be formed integrally with a container. More particularly, the present invention relates to a portable or transportable security device and to methods of using such devices for storing and/or maintaining items of value such as for example, money, jewellery, credit cards, sunglasses, car keys or all manner of portable luggage and the like, in a safe and secure manner, particularly when the owner of the items of value is engaged in another activity and is required to leave the items unattended or the item is removed from one's person by force or deception. The device may be activated by the use of a wireless electronic remote control. Even more particularly, the present invention relates to a security device in the form of a container, such as for example, a bag or similar, which can be used to temporarily store and keep safe items of value when the items must be left unattended whilst the owner of the items of value engages in a recreation pursuit, sport or other activity, preventing the items from being carried on or about the person during the activity, such as for example, whilst playing sport, swimming, exercising or any work related activities. The present invention finds particular application as a temporary security storage device in the form of a briefcase, bum bag, purse, handbag, sports bag, hold all or the like, in which items of value can be left unattended whilst providing security for the contents of the container by arming the security device attached to the bag so that a warning is sounded when there is an attempt to use, move or steal the bag or remove the contents of the bag. Should the item be unarmed it may be activated by the use of a wireless electronic remote control facilitating location therefore discouraging theft.

Although the present invention will be described with particular reference to one or two forms of a bag having the security device of the present invention, it is to be noted that the scope of the present invention is not limited to the described embodiments, but rather the scope of the present invention is more extensive so as to include other forms and arrangements of the security device, including other ways of incorporating the security device into the container or bag, the use of all of the different forms of the security device in a wide variety of applications and to the use of such devices for other purposes.

The incidence of theft is increasing. Although there are many and varied types of security devices, almost all existing security devices are fixed to a substrate or fixed in place in order to be able to provide the necessary security. Even security devices preventing authorised entry into containers such as safes, strong boxes and the like require a fixed substrate of some sort to anchor the security device. However, there have been very few, if any, attempts to provide portable or transportable security devices which can be used to protect items of value when left unattended in the open and in full view of the public, such as for example, when the owner of the items is engaged in an activity where the valuables cannot be carried on or about the person. Such instances occur when a person goes swimming, particularly at the seaside, beaches or the like, or is engaged in other sporting or recreational activities, as well as security transport of valuable goods in portable luggage.

As an example, the theft of motor vehicles from tourist beaches is increasing at an alarming rate. There is an increased incidence of thieves preying upon tourists in the holiday seasons, particularly when tourists are at the beach or are swimming or involved in pursuits or activities that require them to leave their valuables unattended for shorter or longer periods of time or personal luggage is removed by force or deception or the like. In many instances, holiday makers, beach goers, and other tourists are being watched by thieves working together in teams to locate where a tourist keeps their valuables such as car keys, money, credit cards, sunglasses or the like, when visiting beaches, particularly whilst actually swimming. Tourists often place their car keys in shoes, bags or wrap them in their towel or clothes. Often thieves have access to high rise apartments where the activities of tourists on the beach are visible through high-powered binoculars or similar. Wrapping valuables in a towel or hiding the car keys in shoes or similar can be readily observed by a thief using high-powered binoculars. Information about where valuables including car keys are being stored or hidden on the beach can be readily telephoned to an accomplice on the beach by mobile phones who can be directed to the hiding place, bag or the like from the observer in the high rise building or other vantage point. Also, the observer is able to monitor the movements of tourists at the beach to alert the accomplice about the unexpected return of the tourists. In such circumstances, valuables are not safe from professional thieves. Thieves particularly target car keys, not only to steal the motor vehicle but also to unobtrusively gain access to the interior of the car where other valuables my be stored or where information about where the person is staying can be easily obtained. Thieves can readily find details of hotel rooms, or other accommodation being used by the tourist which is then robbed as the tourist remains on the beach and is prevented from readily returning to their accommodation by the theft of their car. Thus, there is a need to provide a safe way of storing valuables such as car keys, locker keys or similar, whilst a person is engaged in swimming or other similar activities that require them to leave their valuables unattended.

Therefore, it is an aim of the present invention to set out to overcome this problem by providing a container or similar such as a bag, fitted with a security device incorporating an alarm system which responds to unauthorised use or movement of the bag to emit a warning, such as a siren wail or similar, thereby alerting people, including the owner of the valuables, in close proximity that the bag has been moved or that there has been an attempt to steal the bag. The unwanted attention of the public and the owner deters would-be thieves from interfering with or removing the bag and similarly should a disarmed unit be removed by force or deception it may be activated by the use of a wireless remote control.

According to one aspect of the present invention, there is provided a portable or transportable security device, typically in the form of a bag, for storing and/or maintaining items of value in safe and/or secure condition when the device is unattended, including a container portion for containing the items of value, a motion sensor for detecting movement of the device, an arming system for arming the security device and an alarm for providing a warning of unauthorised use or movement of the container portion and/or device, such that when the device is armed the alarm is activated to provide a warning of unauthorised use in response to the motion sensor detecting unauthorised use and/or movement of the security device and a wireless electronic remote control to activate the unit whether armed or disarmed, increasing protection provided by the security device of the items of value stored therein against theft or similar.

According to another aspect of the present invention there is provided a method of storing and/or maintaining items of value in a safe and/or secure condition when left unattended or attended including the steps of placing the items of value in a container portion of a security device or a container having a security device, typically a bag, closing the container portion, arming an arming system for arming a motion sensor wherein the motion sensor is connected to an alarm system so that when the motion sensor is armed by operation of the arming means the alarm is activated in response to detection of unauthorised movement or use of the container and/or device by the motion detector to provide an alarm thereby warning of unauthorised use or movement of the device and/or container so as to prevent or reduce the risk of theft of the valuables, bag or device.

Typically, the security device is a container and remote firing unit, more typically a portable or transportable container, such as for example, a bag, purse, hold all, bum bag, briefcase, overnight bag, sports bag or similar. More typically, the security device is attached to or mounted on the bag or is integral with the bag. Even more typically, the security device is located within part of the bag, typically one of the compartments of the bag and is readily accessible from outside the bag to operate the device such as to arm the device or to cancel the warning alarm.

Typically, the motion sensor is a device for detecting movement or motion, typically movement of the bag once armed. Typically, the motion sensor is adjustable to select or change the amount of movement necessary to activate or operate the detector. More typically, the motion sensors are conventional motion sensors, such as for Example . . .

Typically, the arming system is for arming or activating the security device. More typically, the arming system arms the motion sensor or the alarm. Even more typically, the arming system interconnects the motion sensor and the alarm.

Typically, the arming system includes a programmable system. More typically, the arming system is a manually settable arming system. Even more typically, the arming system is a keypad. Even more typically, the arming system is provided with an automatic panic button, switch or similar. Even more typically, the arming system is provided with a cancellation button, switch or similar.

Typically, the security device of the present invention can be used as a warning device in the form of an anti-intruder device or similar that warns or alerts occupants of a room to unauthorised entry into the room, such as for example, attempts to break into holiday accommodation, hotel rooms or the like. The bag fitted with the security device is suspended from the doorhandle of the door of a room so that any unauthorised movement of the door will be detected and activate the alarm when the bag and/or security device is armed.

Typically, the alarm is an audible alarm. More typically, the audible alarm is a siren or other similar device. Even more typically, the siren or alarm emits a 103 or more decibel screech, wail or similar.

Typically the keypad is programmable to alter the code for activating the alarm. Typically the keypad is provided with a cancellation or disabling code or similar.

Typically, the alarm is provided with a time delay.

Typically, the alarm is an entry alarm with keypad, typically incorporating an integral motion sensor.

Typically, the alarm and keypad are provided in a wall of the bag. More typically, within a part of the bag, such as being protectively enclosed within a compartment or pocket provided in the bag.

Typically, the security device is armed by entering a predetermined code through the keypad, such as for example, entering three digits.

Typically, the arming system and warning siren are tamper-proof.

The present invention will now be described by way of example with reference to the accompanying drawings in which:

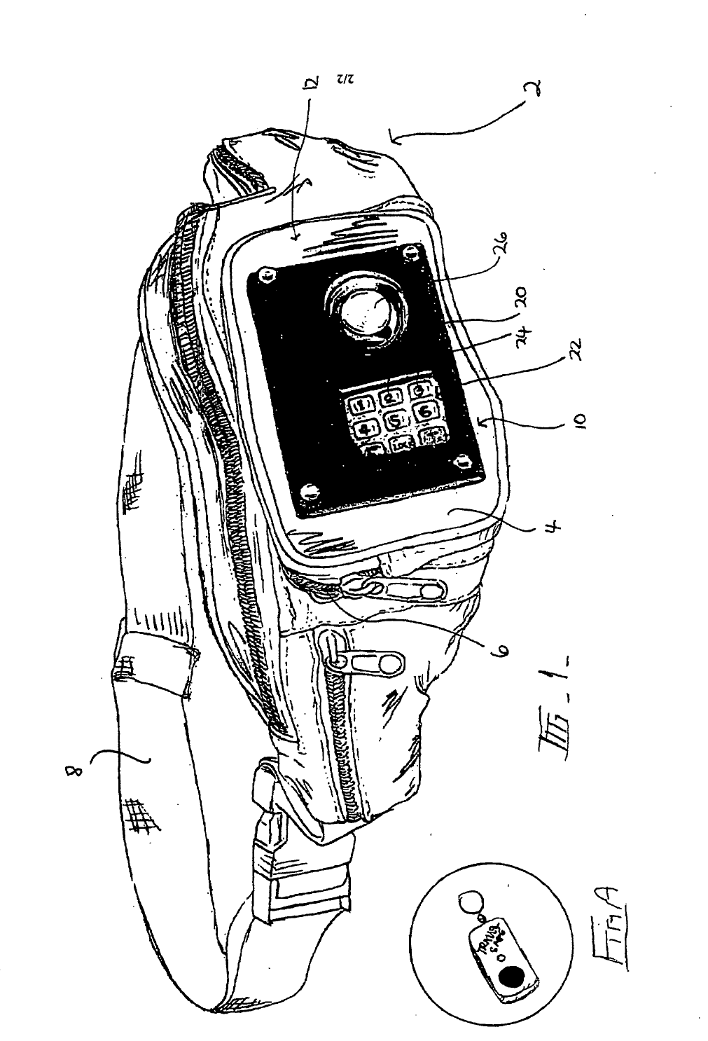

FIG. 1 is a perspective view of one form of the security device of the present invention being in the form of a waist bag or bum bag; and

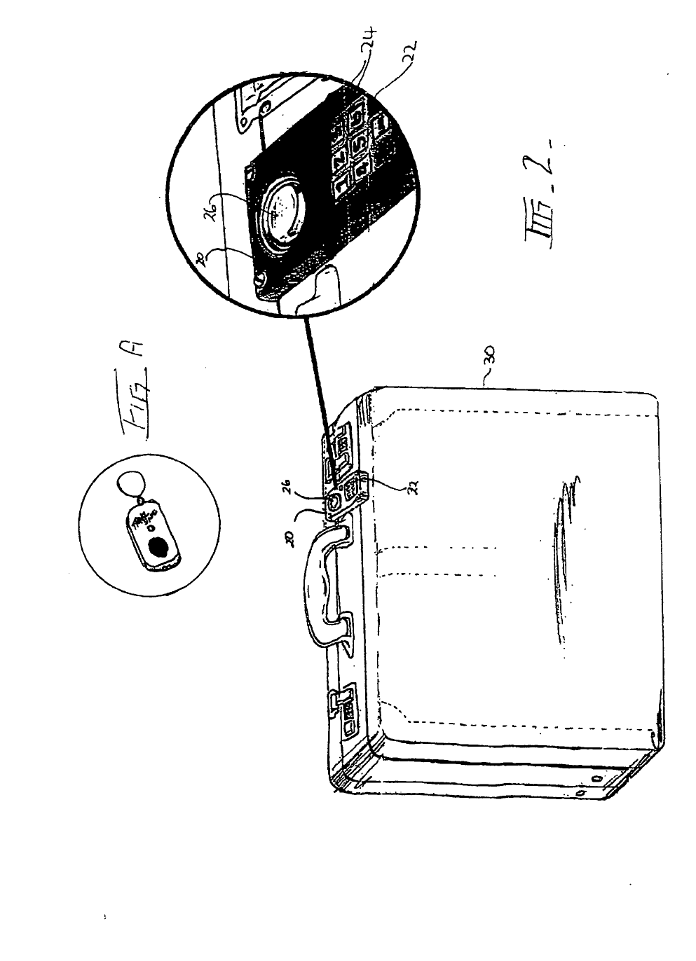

FIG. 2 is a perspective view of another form of the security device of the present invention in the form of a briefcase.

With particular reference to FIG. 1, there is shown a bag, generally denoted as 2, having a number of zippered compartments in which items of value such as car keys, jewellery, watches, credit cards, money, sunglasses, or other personal effects can be stored. In particular, a zippered compartment 4 is provided at the front of the bag 2. Access to the zippered compartment 4 is through zip 6. Zip 6 operates in the conventional manner. It is to be noted that in the security device of the present invention it is not necessary to have locks on the zips since security of the present invention is provided by the alarm fitted to the bag. Any attempt to open any of the zips will cause the alarm to sound.

An adjustable waist strap 8 is provided to allow bag 2 to be worn when in use.

A security subassembly 10 is fixedly connected or otherwise attached to one surface, typically the front surface 12 of compartment 4 of bag 2. In the illustrated embodiment, the security subassembly 10 is mounted on the outside or front surface 12 of the zippered compartment 4 with the various components of the subassembly 10 located within the compartment 4. Thus, the internal working of the security subassembly is protected inside compartment 4. The security subassembly 10 comprises a mounting plate 20 having recessed thereinto a keypad 22 containing a plurality of buttons 22 or similar switches providing different functions for the security device. A motion sensor in the form of a mercury switch or similar (not shown) is located on the reverse side of the mounting plate 20 within compartment 4. An audible alarm in the form of a siren 26 is mounted on the mounting plate 20 adjacent to keypad 22. Siren 26 is provided with a suitable device enabling the sound to be transmitted around bag 2. It is to be noted that operation of keypad 22 arms the motion detector. An indicator in the form of a LED is provided as an indication that the security device has been armed. Power for the various components of the security device is provided by a self-contained power supply, such as batteries or the like.

FIG. 1A—Self contained wireless remote control activator

Operation of the security device of the present invention will now be described.

When a person owning the items of value is to engage in an activity such as swimming in which bag 2 is to be left unattended, the items of value can be stored within one of the zippered compartments, including compartment 4.

When it is required to leave the bag 2 unattended, the predetermined code for arming the device is entered through the buttons 24 or keypad 22. The device is provided with an adjustable delay which can be set in accordance with requirements so that there is time to place the bag containing the valuable items on the sand or other surface before the security device and/or the motion detector is armed. After the bag has been placed on the sand and the time of the predetermined delay has elapsed the bag can be left unattended in the armed state.

When a would-be thief notices the bag left unattended on the sand, the thief makes an attempt to steal the bag or to rifle through its contents seeking car keys or similar valuable. Immediately the bag is disturbed, the motion detector senses the movement of the bag and activates siren 26 to emit a piercing screech or similar audible warning. As soon as the bag begins to emit the audible warning the owner of the bag and people in the close proximity of where the bag is located are alerted to the potential theft of the bag or its contents. As the siren cannot be silenced easily the would-be thief is forced to discard the wailing bag in order to make a getaway to avoid being confronted. The bag can be arranged to continue to emit a loud audible warning noise until it is deactivated by another preselected code being entered by the keypad or there may be a time delay after which having elapsed, the warning noise is stopped and the bag rearms itself. In either event, the attempt theft of the bag or its contents is prevented by people in close proximity to the bag being alerted that an attempt to steal the bag or its contents has been made.

Turning now to FIG. 2, a similar security device is illustrated in the form of a briefcase 30 having the security subassembly 10 connected to one edge of the bag, typically, near to the opening of the bag. The security device of FIG. 2 operates in exactly the same manner as that of FIG. 1 in that the security device 30 when left unattended can be armed by entering a preselected code into the keypad 22 which arms the motion sensor so that any unauthorised movement of the briefcase is detected by the motion sensor which in turn activates the alarm to provide an audible warning that there has been an attempt to steal the briefcase.

FIG. 2A—self contained wireless remote control activator

Advantages of the present invention include the following:

The security device or a suitable container having as security device can be permanently attached to the container to provide protection.

The security device is self-contained and is readily transportable.

The described arrangement has been advanced by explanation and many modifications may be made without departing from the spirit and scope of the invention which includes every novel feature and novel combination of features herein disclosed.

Those skilled in the art will appreciate that the invention described herein is susceptible to variations and modifications other than those specifically described. It is understood that the invention includes all such variations and modifications which fall within the spirit and scope.

1-2. (cancelled)

3. A portable or transportable security device for storing items of value in a safe and/or secure condition when the device is unattended, comprising:
a container portion in which items of value are placed;
a sensor capable of detecting movement of the device;
an arming system which arms or disarms the device;
an alarm; and
a remote control activator,
wherein when the device is armed by the arming system, the alarm is activated to provide a warning of unauthorised use in response to the sensor detecting unauthorised use and/or movement of the security device and wherein said remote control activator is operable to cause actuation of the alarm when said arming system is disarmed.

4. A security device according to claim 3 in which the container portion comprises a separate container onto which the security device is attached or mounted, or is integral with the container portion.

5. A security device according to claim 3 wherein said sensor is a movement detector.

6. A security device according to claim 5 wherein said movement detector comprises a mercury switch.

7. A security device according to claim 3 in which the arming system includes a programmable system.

8. A security device according to claim 3 which the arming system includes a keypad.

9. A security device according to claim 8 in which the security device is armed by entering a predetermined code through the keypad.

10. A security device according to claim 9 in which the keypad is programmable to alter the code for arming the device.

11. A security device according to claim 9 in which the keypad is provided with a cancellation button or switch to cancel operation of the alarm.

12. A security device according to claim 10 in which the keypad is provided with a cancellation button or switch to cancel operation of the alarm.

13. A security device according to claim 3 in which the alarm is an audible alarm.

14. A security device according to claim 9 in which said arming system is armed at a delayed time after entry of said code.

15. A security device according to claim 3 in which the container portion is a bag.

16. A security device according to claim 15 wherein said bag includes a zippered compartment, and wherein said sensor, arming system and alarm form a security subassembly mounted to said compartment, said security subassembly having a mounting plate on a front surface of said zippered compartment, and wherein said arming system comprises a keypad on the front of said mounting plate.

17. A security device according to claim 16 wherein said motion sensor is mounted on the rear of said mounting plate and within said compartment.

18. A security device according to claim 16 wherein said alarm comprises a siren mounted on said mounting plate adjacent said keypad.

19. A security device according to claim 17 wherein said alarm comprises a siren mounted on said mounting plate adjacent said keypad.

20. A method of alerting occupants of a room to unauthorised entry into the room wherein the security device according to claim 3 is suspended from a doorhandle of a door of the room so that any unauthorised movement of the door will be detected and activate the alarm when the security device is armed.

21. A method of storing and/or maintaining items of value in a safe and/or secure condition when left unattended including the steps of:
placing the items of value in a container portion of a security device or a container portion having a security device;
closing the container portion; and
arming an arming system for arming a motion sensor,
wherein the motion sensor is connected to an alarm system which includes a remote control activator, whereby when the sensor is armed by operation of the arming means, the alarm is activated in response to detection of unauthorised movement or use of the container portion and/or device by the motion sensor, thereby warning of unauthorised use or movement of the device and/or container portion and wherein when said arming means is not armed, said alarm can be activated by said remote control activator.
